(19) United States
(12) Patent Application Publication
(10) Pub. No.: US 2015/0247006 A1
(43) Pub. Date: Sep. 3, 2015

(54) Block Copolymers Based on Linear Poly(oxymethylene)(POM) and Hyperbranched Poly(glycerol): Combining Polyacetals with Polyethers

(71) Applicant: Ticona GmbH, Sulzbach (DE)

(72) Inventors: Rebecca Klein, Mainz (DE); Christoph Schüll, Mainz (DE); Michael Haubs, Bad Kreuznach (DE); Klaus Kurz, Kelsterbach (DE); Holger Frey, Mainz (DE)

(21) Appl. No.: 14/309,440

(22) Filed: Jun. 19, 2014

Related U.S. Application Data
(60) Provisional application No. 61/837,446, filed on Jun. 20, 2013.

(51) Int. Cl. C08G 81/00

(52) U.S. Cl. CPC C08G 81/00

(57) ABSTRACT

Synthesis of hyperbranched-linear-hyperbranched ABA triblock copolymers based on linear poly(oxy methylene) (POM) and hyperbranched poly(glycerol) (hbPG) blocks is described. The polymers having a polyacetal polyether structure were prepared from linear bishydroxy functional POM macroinititators, obtained by cationic ring-opening polymerization of trioxane and dioxane with formic acid as transfer agent and following hydrolysis of the formiate group. Partial deprotonation of the resulting hydroxyl groups permitted the hypergrafting by anionic ring-opening multibranching polymerization (ROMBP) of glycidol.

### RELATED APPLICATIONS

The present application is based upon and claims priority to U.S. Provisional Patent Application having Ser. No. 61/837,446, filed on Jun. 20, 2013, and which is incorporated herein by reference.

### BACKGROUND

Polyoxymethylene, which is obtained by cationic or anionic polymerization of formaldehyde, but mostly by the ring opening polymerization of trioxane is a highly useful material because of its excellent mechanical properties such as high tensile strength and high impact strength. Furthermore, polyoxymethylene is stable over a broad temperature range, has low moisture absorption and is resistant to most organic solvents and water. Due to the polyacetal repeat units, polyoxymethylene can degrade slowly when heated causing formaldehyde release. To prevent this so called “unzipping” mechanism, trioxane is copolymerized with cyclic ethers, e.g., ethylene oxide, 1,3-dioxolane, 1,3-dioxepane or comparable structures. The unzipping still takes place, but the degradation stops, as soon as the polyacetal structure is interrupted by a C—C-bond of the comonomer. The copolymerization affects the crystallinity of polyoxymethylene resulting in a lower melting point. Copolymerization improves the processibility and opens the broad application spectrum for this material, such as for use as bearings, gearwheels and housing parts often under extremely high loads.

Still high crystallinity and insolubility in common solvents are demanding challenges for further chemical functionalization of the polymer. There have been some attempts to vary the properties of polyoxymethylene by introducing functional groups into the polymer. These attempts rely mainly on three ways: The conversion of hydroxyl end groups with suitable reagents, the integration of functional groups by transfer reactions during the polymerization, or the copolymerization of trioxane with functional monomers.

Although some advances have been made to modify polyoxymethylene polymers, further improvements are still needed. In particular, a need exists for a process for producing a polyoxymethylene polymer with a greater amount of functional groups. A need also exists for a process for controlling the properties of a polyoxymethylene polymer in order to tailor the polymer to an end use application. A need also exists for a process that can vary different properties of the polyoxymethylene polymer, such as the hydrophilic properties of the polymer and/or the solubility of the polymer in various solvents.

### SUMMARY

In general, the present disclosure is directed to hyperbranched polyoxymethylene polymers and to a process for producing the polymers. As used herein, a “hyperbranched” polymer refers to a polymer having a highly branched molecular architecture that has tree-like macromolecules and a large number of end groups. Hyperbranched polymers are part of a class of polymers referred to as dendritic polymers. Dendrimers are polymers defined as monodisperse hyperbranched polymers. Other hyperbranched polymers, on the other hand, may be polydisperse. In accordance with the present disclosure, any hyperbranched polymer structure may be formed by controlling the reactants and the reaction conditions.

In one embodiment, hyperbranched polymers according to the present disclosure, as opposed to having an almost spherical shape, have a high degree of branching and a less well-defined intramolecular cargo space. For instance, hyperbranched polymers according to the present disclosure can have random branching and irregular structures.

In one embodiment, the hyperbranched polymer of the present disclosure includes a polyoxymethylene middle portion or core. The polyoxymethylene core structure may be linear. The polyoxymethylene core portion may be grafted at each end to hyperbranched portions. The hyperbranched portions may have a densely branched structure with a large number of end groups. In accordance with the present disclosure, at least some of the end groups and, in one embodiment, all of the end groups, may comprise a functional group. In this manner, polymers can be produced having a unique combination of properties.

In one particular embodiment, the present disclosure is directed to a hyperbranched-linear-hyperbranched ABA triblock copolymer that includes a linear polyoxymethylene middle portion grafted to hyperbranched blocks, such as polyglycerol blocks. The polyglycerol blocks may provide the polymer with a significant number of hydroxyl end groups. The resulting polymer not only has excellent mechanical and thermal properties, but also has excellent solubility properties due to the presence of the hyperbranched polyether polyols. The resulting polymer may be produced to have hydrophilic surfaces. In one embodiment, the polymer can be produced in the form of nanoparticles. In one embodiment, the polymer molecules may have an amphiphilic structure.

In one particular embodiment, the present disclosure is directed to a polyoxymethylene polymer comprising a hyperbranched polyoxymethylene homopolymer or copolymer. The polyoxymethylene homopolymer or copolymer comprises a middle portion positioned between a first end portion and a second end portion. At least one of the end portions has a hyperbranched structure. For instance, in one embodiment, both end portions may have a hyperbranched structure. The middle portion may comprise a linear structure having repeating oxymethylene units and optionally other oxyalkylene units.

Each hyperbranched portion of the molecule may have at least about 10 branches per molecule, such as at least 15 branches per molecule, such as at least 20 branches per molecule, such as at least 25 branches per molecule, such as at least 30 branches per molecule, such as at least 35 branches per molecule, such as at least 40 branches per molecule, such as at least 45 branches per molecule, such as at least 50 branches per molecule. In general, each hyperbranched portion has less than about 500 branches, such as less than about 400 branches, such as less than about 300 branches, such as less than about 200 branches.

Each hyperbranched portion can include end units. The end units may comprise functional groups, such as hydroxyl groups. In one embodiment, at least 80% of the end groups, such as at least about 90% of the end groups, such as up to about 100% of the end groups can comprise the functional groups. The hyperbranched portion of the molecule may be aliphatic and can include ether linkages.

The present disclosure is also directed to a process for producing a hyperbranched polyoxymethylene polymer. The process includes the steps of at least partially deprotonating hydroxy terminal groups on a polyoxymethylene polymer or oligomer. The deprotonated polyoxymethylene polymer or oligomer is then reacted with a multi-functional hyperbranching monomer. The multi-functional hyperbranching monomer grafts to the polymer or oligomer and further polymerizes to form a polyoxymethylene polymer with at least one hyperbranched portion. In one embodiment, the polyoxymethylene polymer or oligomer comprises a bishydroxy polyoxymethylene. The multi-functional hyperbranching monomer may comprise glycidol or another suitable monomer.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIGS. 1-4 are graphical representations of the results obtained in the examples below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to hyperbranched polyoxymethylene polymers. In one embodiment, the hyperbranched polymer includes a middle portion or core portion that comprises a polyoxymethylene homopolymer or copolymer. For example, the middle portion may comprise oxymethylene repeat units alone or in combination with other oxyalkylene units, such as oxyethylene units. The polymer may include at least one end portion that has a hyperbranched structure. In one embodiment, the core portion made from a polyoxymethylene polymer is grafted at one end to a hyperbranched structure and grafted at an opposite end to another hyperbranched structure.

The hyperbranched polyoxymethylene polymers of the present disclosure offer many advantages and benefits. For example, the hyperbranched structures provide the polymer with a large number of end groups. In accordance with the present disclosure, different end groups can be attached to the polymer for providing the polymer with various properties. In one embodiment, for instance, the hyperbranched polymer may include a significant number of hydroxy end groups. The hydroxy end groups can provide reactive sites for grafting, coupling, or otherwise attaching the polymer to other compounds. The hydroxy end groups may also increase the hydrophilic properties of the polymer.

In addition to hydroxyl groups, various other functional groups can be incorporated into the hyperbranched structure of the polyoxymethylene polymer. The functional groups may occupy greater than about 20% of all the terminal groups present on the polymer, such as greater than about 30%, such as greater than about 40%, such as greater than about 50%, such as greater than about 60%, such as greater than about 70%, such as even greater than about 80% of all the terminal groups on the polymer. The functional groups, for instance, can occupy up to 100% of the terminal groups on the polyoxymethylene polymer molecule.

In one embodiment, the hyperbranched polyoxymethylene polymer of the present disclosure may be amphiphilic. In particular, the polyoxymethylene core portion of the polymer may be hydrophobic, while the highly branched structures may be hydrophilic. Such a polymer may have many different and unique applications that previously were not available for polyoxymethylene polymers.

Another property that may be improved by the presence of the hyperbranched structure in the polyoxymethylene polymer is the solubility of the polymer. The hyperbranched structure, for instance, may make the polymer more soluble in some solvents, such as organic solvents.

The hyperbranched structure incorporated into the polymer may also influence the viscosity characteristics of the polyoxymethylene polymer. Hyperbranched polymers, for instance, sometimes demonstrate a non-Newtonian relationship between viscosity and molecular weight. In particular, hyperbranched polymers may have lower viscosities at higher molecular weights.

In order to produce hyperbranched polyoxymethylene polymers in accordance with the present disclosure, in one embodiment, a hydroxy terminated polyoxymethylene polymer or oligomer is at least partially deprotonated. The polyoxymethylene polymer may comprise a polyoxymethylene homopolymer or a polyoxymethylene copolymer. For example, in one embodiment, the polyoxymethylene polymer may have a linear structure having repeating oxymethylene units and other oxyalkylene units, such as oxyethylene units.

In order to partially deprotonate the polyoxymethylene polymer or oligomer, the polymer is contacted with a base while water is removed. In one embodiment, a strong base is used. The strong base, for instance, may comprise a hydroxide, such as a metal hydroxide. For instance, the base may comprise cesium hydroxide, potassium hydroxide, sodium hydroxide, or mixtures thereof. Strong organic bases may also be used. An example of a strong organic base is a bicyclic guanidine. Besides guanidines, various other nitrogen-containing organic bases can be used including phosphazenes or amidines, as long as the organic base does not adversely affect the properties of the polyoxymethylene polymer.

Once the polyoxymethylene polymer or oligomer is at least partially deprotonated, the deprotonated polyoxymethylene is then reacted with a multi-functional hyperbranching monomer. The multi-functional hyperbranching monomer grafts to the polymer or oligomer and then further polymerizes to form a polyoxymethylene polymer with a hyperbranched portion.

In one embodiment, the process for producing the hyperbranched polyoxymethylene polymer may be represented as follows:

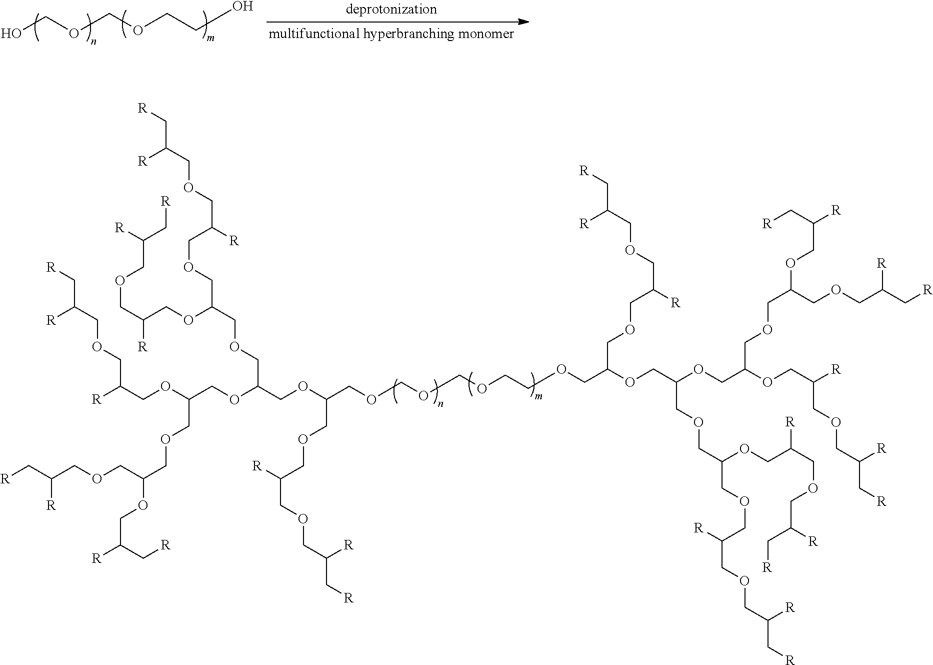

As shown above, the hyperbranched polyoxymethylene polymer includes a middle portion positioned in between a first end portion and a second end portion. In the embodiment above, both end portions have a hyperbranched structure.

The middle portion in the embodiment above comprises a linear polyoxymethylene copolymer. In one embodiment, the polyoxymethylene copolymer can be produced by polymerizing trioxane with 1,3-dioxolane. The end portions having the hyperbranched structure can include multiple ether linkages. In addition, the hyperbranched structures can include terminal groups R. The terminal groups R may comprise the same groups or different groups. In one embodiment, the terminal groups comprise functional groups. Functional groups that may be incorporated into the polymer include hydroxy groups, amino groups, alkoxyl groups, esters or amides.

As shown above, the hyperbranched structures include a significant number of branches and therefore a significant number of terminal groups. For instance, each hyperbranched portion on the polymer molecule may have at least 10 branches, such as at least 15 branches, such as at least 20 branches, such as at least 25 branches, such as at least 30 branches, such as at least 35 branches, such as at least 40 branches, such as at least 45 branches, such as at least 50 branches. In general, each hyperbranched portion will have less than about 500 branches, such as less than about 400 branches, such as less than about 300 branches.

Depending upon the multi-functional hyperbranching monomer used to produce the hyperbranched polymer, in one embodiment, a triblock copolymer can be produced. The triblock copolymer may have an ABA structure in which the A units are the repeating units that make up the hyperbranched portion while the B units comprise the oxymethylene units. In the embodiment illustrated above, the hyperbranched portions are aliphatic.

The multi-functional hyperbranching monomer is generally any suitable multi-functional monomer capable of grafting to the polyoyxmethylene polymer chain while also producing a hyperbranched structure. In one embodiment, for instance, the multi-functional hyperbranching monomer may comprise glycidol. Glycidol includes an epoxy group in conjunction with a CH₂OH group.

In one particular embodiment, when using glycidol as the multi-functional hyperbranching monomer, the reaction sequence for producing a hyperbranched polyoxymethylene polymer in accordance with the present disclosure is illustrated below.

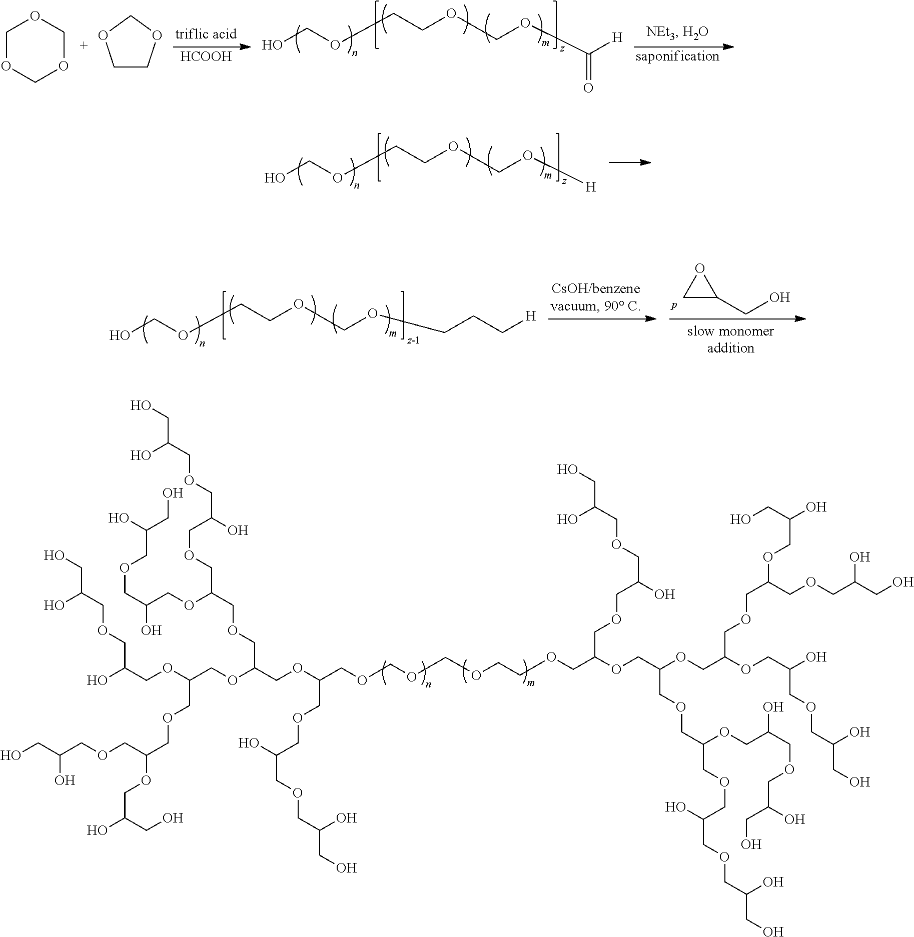

In the first step, linear bishydroxyalkylfunctional poly(oxy methylene) polymer was prepared by cationic ring-opening polymerization of trioxane and dioxolane with formic acid as a transfer agent. The resulting formate end groups were hydrolyzed to obtain the bishydroxy end-functional POM, which serves as a macroinitiator for the ensuing hypergrafting reaction of glycidol to build up the two hyperbranched blocks. The high stability of the POM macroinitiators ensures chemical stability during the basic conditions of the anionic ring-opening multibranching polymerization (ROMBP) of glycidol. To prepare the reactive initiator for the ROMBP, the hydroxyl groups of POM were partially deprotonated (10 mol %) using cesium hydroxide. As shown above, only one hydroxyl group at each chain end can serve as initiator. This is due to the crystalline structure of POM, where the functional end groups always stick out of the surface of the crystal and thereby can be addressed by the glycidol monomers. In some embodiments, the molecular weight of the hbPG-blocks can be limited on each side of the POM macroinitiator. This is due to the increasing viscosity of the products and the low number of alkoxide end groups at high degree of polymerization. For instance, in some embodiments, the molecular weight of the hyperbranched polyglycerol blocks can be less than about 6,000 g/mol, such as less than about 5,000 g/mol. In other embodiments, however, higher molecular weight end blocks may be possible.

In order to produce the hyperbranched portions, the multi-functional hyperbranching monomer may be added gradually to the polyoxymethylene polymer or oligomer that serves as the macroinitiator. The amount of monomer added to the macroinitiator can vary depending upon the particular application and the particular monomer used. In general, the weight ratio of the macroinitiator (deprotonated polymer) to the multi-functional hyperbranched monomer is from about 1:0.1 to about 1:10, such as from about 1:0.5 to about 1:5.

In the embodiment described above, the polyoxymethylene polymer or oligomer that undergoes deprotonization includes terminal hydroxy groups. The polyoxymethylene preferably has terminal hydroxyl groups, for example hydroxyethylene groups (—OCH₂CH₂—OH) and hemi-acetal groups (—OCH₂—OH). According to one embodiment, at least 50%, more preferably at least 75% of the terminal groups of the polyoxymethylene are hydroxyl groups, especially hydroxyethylene groups.

The content of hydroxyl groups end groups is especially preferred at least 80%, based on all terminal groups. The term “all terminal groups” is to be understood as meaning all terminal and—if present—all side terminal groups. As described above, in one embodiment, the polyoxymethylene polymer or oligomer comprises a bis-hydroxy polyoxymethylene.

In addition to the terminal hydroxyl groups, the POM may also have other terminal groups usual for these polymers. Examples of these are alkoxy groups, formate groups, acetate groups or aldehyde groups. According to a preferred embodiment of the present invention the polyoxymethylene (A) is a homo- or copolymer which comprises at least 50 mol-%, preferably at least 75 mol-%, more preferably at least 90 mol-% and most preferably at least 95 mol-% of CH₂O-repeat units.

The polyoxymethylene generally can have a melt volume rate MVR of less than 1000 cm³/10 min, preferably ranging from 1 to 500 cm³/10 min, further preferably ranging from 1 to 200 cm³/10 min, more preferably ranging from 1 to 100 cm³/10 min, determined according to ISO 1133 at 190° C. and 2.16 kg.

The polyoxymethylene can have a content of terminal hydroxyl groups of at least 5 mmol/kg, preferably at least 10 mmol/kg, more preferably at least 50 mmol/kg and most preferably ranging from 50 to 500 mmol/kg.

The content of terminal hydroxyl groups can be determined as described in K. Kawaguchi, E. Masuda, Y. Tajima, Journal of Applied Polymer Science, Vol. 107, 667-673 (2008).

The preparation of the polyoxymethylene can be carried out by polymerization of polyoxymethylene-forming monomers, such as trioxane or a mixture of trioxane and dioxolane, in the presence of a molecular weight regulator or transfer agent. The transfer agent may comprise, for instance, formic acid or ethylene glycol. The polymerization can be effected as precipitation polymerization or in particular in the melt. Initiators which may be used are the compounds known per se, such as trifluoromethane sulfonic acid or triflic acid. The procedure and termination of the polymerization and working-up of the product obtained can be effected according to processes known per se. By a suitable choice of the polymerization parameters, such as duration of polymerization or amount of molecular weight regulator, the molecular weight and hence the MVR value of the resulting polymer can be adjusted. The criteria for choice in this respect are known to the person skilled in the art. The above-described procedure for the polymerization leads as a rule to polymers having comparatively small proportions of low molecular weight constituents.

The hydroxy functional POM, in accordance with the present disclosure, is partially deprotonized and then reacted with a multi-functional hypergrafting monomer in order to form hyperbranching structures on the polymer molecule. The hyperbranching structures can be initiated at a hydroxy end group. In one embodiment, the resulting polyoxymethylene polymer may include a hyperbranched structure at one end of the polymer or at both ends of the polymer.

Hyperbranched polyoxymethylene polymers made in accordance with the present disclosure can be produced to have different properties. For instance, depending upon the monomers used and the macroinitiator, low molecular weight polymers or high molecular weight polymers can be produced. In one embodiment, for instance, a low molecular weight polymer may be produced that has a molecular weight of less than about 10,000 g/mol, such as less than about 8,000 g/mol. In general, the molecular weight is greater than about 1,000 g/mol. In other embodiments, the molecular weight may be greater than about 10,000 g/mol, such as greater than about 20,000 g/mol, such as greater than about 25,000 g/mol, such as greater than about 30,000 g/mol, such as greater than about 35,000 g/mol, such as greater than about 40,000 g/mol. The polydispersity M_{w}/Mₙ) of the polymer can be relatively narrow. For instance, the polydispersity can be in the range of from about 1.3 to about 1.9.

In addition to the above, material properties such as thermal behavior and thermal stability, degree of crystallization, and surface properties can also be adjusted based upon the monomers used and the reaction conditions. For instance, the addition of the hyperbranched structures allows for control over the hydrophilicity of the polyoxymethylene polymer.

The hyperbranched polyoxymethylene polymer of the present disclosure can be used in numerous and diverse applications. Because of the possibility for adjusting hydrophilicity, the hyperbranched polymer can be used as an additive in polyoxymethylene polymer compositions. For instance, the hyperbranched polyoxymethylene polymer may be combined with a non-hyperbranched polyoxymethylene polymer. In this embodiment, the hyperbranched polymer may be present in the composition in an amount from about 0.5% to about 50% by weight, such as in an amount from about 3% to about 30% by weight. Combining the hyperbranched polyoxymethylene polymer with a more conventional polyoxymethylene polymer may control the overall hydrophobicity of the resulting composition. The hyperbranched polyoxymethylene polymer may also have an impact on the viscosity of the resulting composition.

As described above, the hyperbranched polyoxymethylene polymer may also have an amphiphilic structure. In this regard, the hyperbranched polyoxymethylene polymer may be used to form soluble, acid labile polyoxymethylene nanoparticles.

The hyperbranched polyoxymethylene polymer of the present disclosure can also be used as the basis for a polymer composition for producing molded articles. When used to produce molded articles, for instance, the hyperbranched polymer may be pelletized and mixed with various additives. For instance, the composition may be combined with colorants, light stabilizers, antioxidants, heat stabilizers, processing aids, and fillers.

Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). In one embodiment, the light stabilizer may comprise 2-(2H-benzzotriazol-2-yl) 4,6-bis(1-ethyl-1-phenyl-ethyl)phenol (Tinuvin 234). Other hindered amine light stabilizers that may be used include oligomeric compounds that are N-methylated. For instance, another example of a hindered amine light stabilizer comprises ADK STAB LA-63 light stabilizer available from Adeka Palmarole.

One or more light stabilizers may be present in the composition in an amount generally less than about 5% by weight, such as in an amount less than 4% by weight, such as in an amount less than about 2% by weight. The light stabilizers, when present, can be included in amounts greater than about 0.1% by weight, such as in amounts greater than about 0.5% by weight.

The above light stabilizers may protect the composition from ultraviolet light. In addition to the above light stabilizers, UV stabilizers or absorbers that may also be present in the composition include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

The composition can be melt processed to form various different articles.

The present disclosure may be better understood with reference to the following examples.

### EXAMPLES

Instrumentation. ¹H-NMR spectra were recorded at 600 MHz on a Bruker Avance III at 37° C. and are referenced internally to residual proton signals of the deuterated solvent.

For SEC measurements in HFIP (containing a 0.05 molar solution of KFAc in HFIP), a Jasco LC-NetII/ADC was used as an integrated instrument including a PSS PFG 100 A column and a RI detector. Calibration was achieved with poly(methyl methacrylate) provided by Polymer Standards Service (PSS). DSC measurements were carried out on a Perkin-Elmer DSC 8500 in the temperature range of −95° C. to 180° C. at heating rates of 10 K min⁻¹ under nitrogen.

TGA measurements were carried out on a Perkin-Elmer Pyris 6 in the temperature range of 30° C. to 700° C. at heating rates of 30° C. min⁻¹.

FT-IR measurements were performed on a Thermo scientific Nicolet iS10 and an ATR unit in the wave number range of 500 cm⁻¹ to 3500 cm⁻¹

Matrix-assisted laser desorption and ionization time-of-flight mass spectrometry (MALDI-ToF MS) measurements were carried out on a Shimadzu Axima CFR MALDI-ToF mass spectrometer using dithranol (1,8,9-tris(hydroxyanthracene)) as a matrix. The samples were prepared from HFIP and ionized by adding aliquots of potassium triflate.

Contact angle measurements were performed on a Dataphysics Contact Angle System OCA using water as interface agent.

General Procedures, Polymerization. Trioxane, preheated to 80° C., dioxolane and formic acid were presented in a beaker glass and stirred vigorously. Triflic acid was added and the resulting polymer diluted in NMP, some triethylamine and water were added and heated to 100° C. After 30 min the water was removed by distillation and the solution was again heated to 140° C. for 2 h. Then the mixture was allowed to cool down to 65° C. and filtrated. The filter cake was diluted in methanol and again heated to 70° C. for 1 h. The polymer was dried in vacuo after filtration of the mixture (yield: 42%). SEC (HFIP, PMMA-Std.): Mₙ=13 400 g/mol; M_{w}=24 200 g/mol; PDI=1.81. ¹H-NMR (HFIP-d₂, 600 MHz): δ [ppm]=5.20-5.00 (—CH₂-polymer main chain); 5.00-4.95 (—CH₂-dioxolane); 3.95-3.90 (—CH₂-dioxolane).

Hypergrafting. The linear macroinitiator was placed in a Schlenk flask and suspended in benzene (10 wt %). Subsequently the appropriate amount of cesium hydroxide was added to achieve 10% of deprotonation of the hydroxyl groups. After stirring for 30 min, benzene was removed in vacuo at 60° C. over night. DMAc was added and the mixture was heated to 140° C. to ensure complete dissolving of the macroinitiator. A 10 wt % solution of glycidol in DMAc was added slowly with a syringe pump over a period of approximately 24 h. The reaction was terminated by addition of an excess of methanol and weak acidic cation exchange resin. The products were separated by centrifugation and washed with methanol three times. The resulting triblock copolymer was dried in vacuo for 2 days (yield: 58%). SEC (HFIP, PMMA-Std.): Mₙ=14 000 g/mol; M_{w}=24 900 g/mol; PDI=1.77. ¹H-NMR (HFIP-d₂, 600 MHz): δ [ppm]=5.15-5.00 (—CH₂-POM chain); 5.00-4.95 (—CH₂-dioxolane); 4.10-3.60 (—CH₂-dioxolane+hbPG backbone). ¹³C solid state NMR (8 kHz): δ[ppm]=100-80 (—CH₂-POM-chain); 75-65 (—CH₂-hbPG-chain).

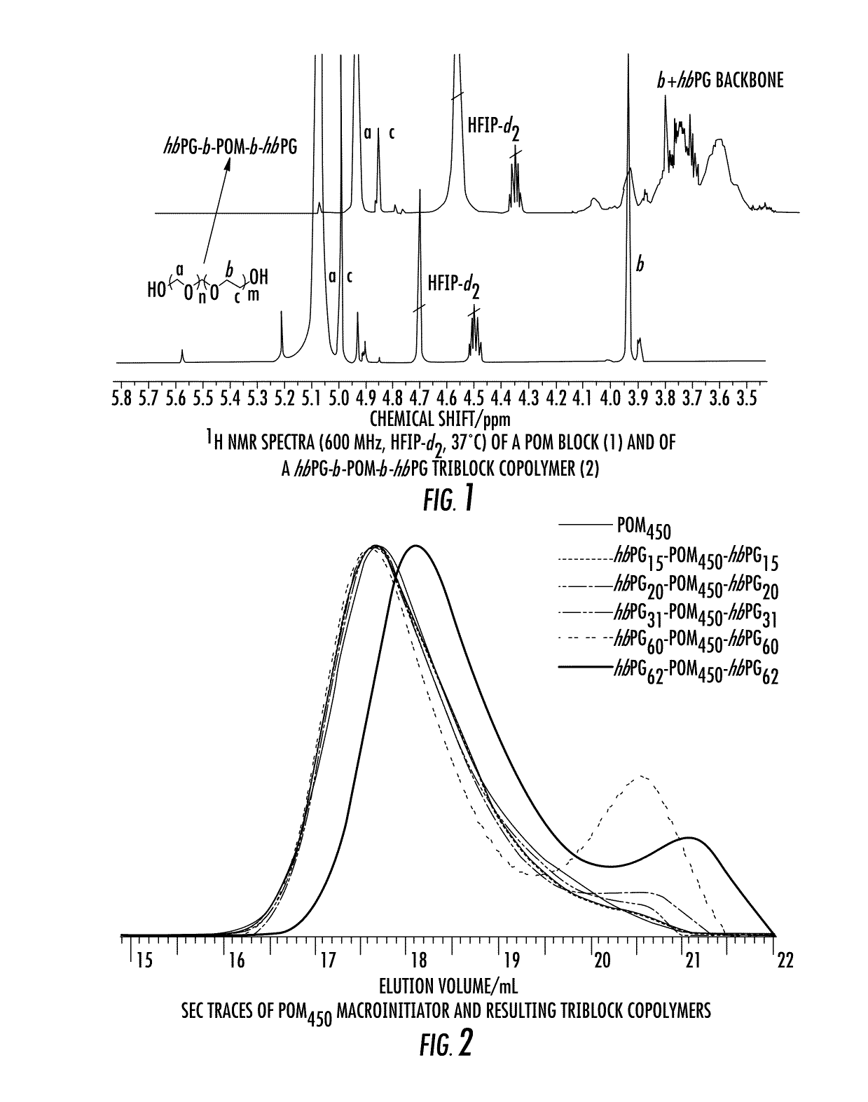

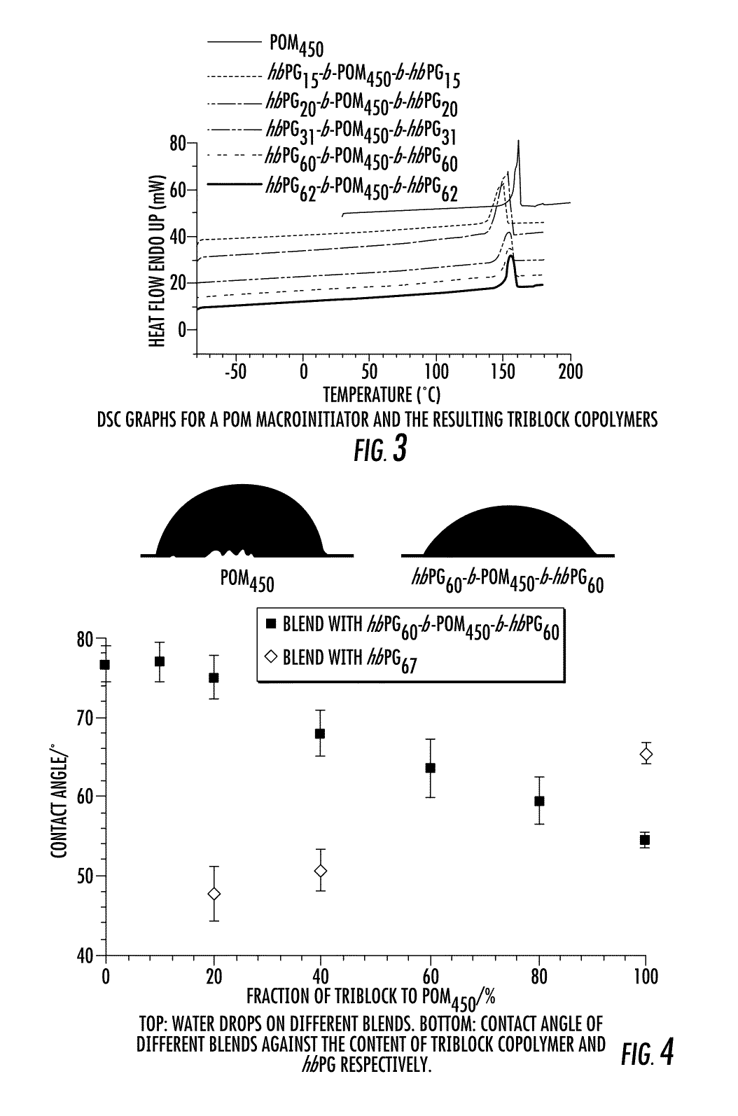

Proof of successful hypergrafting. The solubility of the hyperbranched POM in polar solvents was not significantly influenced. This might be due to the high crystallinity of POM, having a stronger influence on the solubility of the polymers than the increasing quantity of hydroxyl groups on the hbPG blocks. The preservation of insolubility despite the introduction of the hbPG blocks is very positive, because the copolymerization approach has only low influence on this important property. The polymers do show an excellent solubility in HFIP. ¹H-NMR spectroscopy (FIG. 1) in HFIP-d₂opened the possibility to follow the hypergrafting step. The ¹H NMR spectrum of the hbPG-b-POM-b-hbPG triblock proves successful hypergrafting of glycidol and buildup of the hyperbranched blocks, which can be seen by the newly emerging peaks from 3.50 to 4.20 ppm corresponding to the polyether backbone of hbPG. The hbPG signals can only belong to successfully hypergrafted glycidol, because hbPG homopolymer is separated by washing the reaction mixture with methanol.

Additionally, the materials were investigated by ¹³C solid state NMR because of the insolubility of the polymer, where the signals for POM (80-100 ppm) as well as hbPG(65-75 ppm) can be assigned. For further verification of the successful hypergrafting the samples were additionally characterized by FT-IR and MALDI-ToF mass spectrometry. In the FT-IR spectra the triblock copolymer shows strong increase of the hydroxyl peak at around 3400 cm⁻¹in comparison to the POM macroinitiator. Secondary, the methylene stretch signal at 2920 cm⁻¹ increases. By hypergrafting with glycidol the number of methylene and hydroxyl groups increases, which explains the described results. Therefore, the FT-IR indicates a successful hypergrafting. Also, the MALDI-Tof MS spectra, exemplary shown for sample hbPG₁₃-b-POM₂₀₀-b-hbPG₁₃ confirm these results, because all three repeating units (—CH₂—O—; 30.03 g/mol; —CH₂—CH₂—O—: 44.05 g/mol and —CH₂—CHO—CH₂O—: 73.07 g/mol) can be assigned. Considering the described characterization methods, a hyperbranched-linear-hyperbranched triblock copolymer based on linear POM and hbPG was produced.

Molecular weight determination. The molecular weight determination in solution was carried out in HFIP because of the insolubility of the polymers in conventional organic solvents. POM has no functional end-groups, which can be used for the relative integration in the ¹H NMR spectrum to determine the number average molecular weight. Therefore, the hydroxyl groups of the POM macroinitiator were functionalized with phenyl isocyanate. The aromatic signals (7.30-7.50 ppm) can be clearly assigned, which allows relative integration of the end-group and the backbone signals assuming quantitative functionalization of the end groups, which can be explained with the high reactivity of isocyanates against hydroxyl groups. Analytical data of the POM₄₅₀ macroinitiator and the corresponding triblock copolymers is summarized in Table 1. The molecular weight determined via ¹H NMR spectroscopy ranges of 13,900 g mol⁻¹ for the POM macroinitiator to 23,200 g mol⁻¹ for the biggest triblock copolymer, which equates to two 4600 g mol⁻¹ hbPG blocks. In SEC, the resulting molecular weights are in the range of 13,100 to 22,100 g mol⁻¹. Moreover, moderate to narrow molecular weight distributions (PDI=1.3-1.8) confirm the well-defined structure of the triblock copolymer. The molecular weights determined with SEC do not accompany the molecular weights calculated with ¹H NMR. One reason is a changing in the hydrodynamic volume due to numerous hydroxyl functions undergoing hydrogen bonding. Furthermore, the polymer-column interaction increases, which increases the retention time on the column. The combination of both explanations can lead to steady molecular weights. But in comparison with the POM macroinitiator the molecular weight of the triblock copolymers changes in all cases. In some SEC traces (FIG. 2), a second mode is observable, which may be caused by incomplete functionalized POM.

TABLE 1
Characterization Data for Triblock Copolymers Based on POM₄₅₀
Obtained from ¹H NMR Spectroscopy and SEC

| no. | composition (NMR) | M_{n,}^{a}/gmol⁻¹ | M_{n,}^{b}/gmol⁻¹ | M_{w}/Mₙ^{b} |
|---|---|---|---|---|
| 1 | POM₄₅₀ | 13900 | 13400 | 1.81 |
| 2 | hbPG₁₅-b-POM₄₅₀-b-hbPG₁₅ | 16100 | 13800 | 1.81 |
| 3 | hbPG₂₀-b-POM₄₅₀-b-hbPG₂₀ | 16900 | 18500 | 1.40 |
| 4 | hbPG₃₁-b-POM₄₅₀-b-hbPG₃₁ | 18500 | 14500 | 1.70 |
| 5 | hbPG₆₀-b-POM₄₅₀-b-hbPG₆₀ | 22900 | 22100 | 1.33 |
| 6 | hbPG₆₂-b-POM₄₅₀-b-hbPG₆₂ | 23200 | 13100 | 1.32 |

^{a}Calculated from ¹H NMR spectra.
^{b}Determined by SEC-RI in HFIP using PMMA standards.

Thermal Properties and Crystallinity. In order to further evaluate the properties of the triblock copolymers, the thermal properties were investigated via differential scanning calorimetry (DSC) and thermogravimetric analysis (TGA) measurements. POM shows a melting range from 175 to 185° C. for homopolymers (only trioxane) and of 165° C. for copolymers in strong dependency of the dioxolane content and a glass transition temperature at −82 ° C. In contrast, hbPG shows glass transitions around −20° C. depending on molecular weight and number of free hydroxyl groups. The hbPG-b-POM-b-hbPG triblock copolymers showed lower melting points compared to the POM macroinitiators ranging from 144.3° C. to 165.4° C. (Table 2). For the triblock copolymer with 14.1% relative hbPG content there is no glass transition observable, because the influence of the small hbPG blocks is too low to change the thermal behavior of the POM block. But for a hbPG content of 18.0%, a T_{g} of −67.0° C. appears, which goes up to −47.4° C. for 39.7% relative hbPG content. The glass transition changes from POM-like to hbPG-like with increasing hbPG content and therefore higher influence of the hbPG properties on the thermal properties of the whole triblock. blend of POM₄₅₀ and hbPG₁₄ was measured showing a melting point of 161.7° C. and a glass transition at −33.5° C., which correlates to a POM melting temperature and a hbPG glass transition. So, the observed thermal behavior of the triblock copolymers is another proof for the successful hypergrafting and covalent linkage between hbPG and ROM. Additionally, with increasing hbPG content the melting enthalpy decreases from 138.0 to 90.2 Jg⁻¹, which allows conclusions on the crystallinity of the polymers. The crystallinity (X_{c}) can be calculated by dividing the melting enthalpy (ΔHₘ) by the melting enthalpy for POM with 100% crystallinity (ΔHₘ^{∞}) and multiplying this with the relative fraction of POM (f_{ω}^{POM}) (eq. 1).

$${X}_{c} = \frac{Δ {H}_{m}}{Δ {H}_{m}^{∞}} {f}_{ω}^{POM} \qquad ( 1 )$$

The melting enthalpy for 100% crystalline POM (ΔHₘ^{∞}) is 326.3 J/g, while a POM homopolymer has a degree of crystallinity around 65%. In our case the crystallinity for the POM macroinitiator containing trioxane and dioxolane amounts 42.3% and decreases to 16.8% for the biggest triblock copolymer with only 60.3% POM weight fraction. The growth of POM-crystals corresponds directly to the chain growth of the POM. By addition of trioxane to the reactive chain end, localized on the surface of the crystal, a two dimensional growth of the crystal is achieved. The POM chain ends lie stretched side-by-side while the functional end groups stick out of the surface. By using these functional groups as initiators for the ring-opening polymerization of glycidol, the crystal structure is disturbed because of higher place requirement of the hbPG blocks. The bigger the hbPG block the higher the place requirement and the lower the crystallinity. Therefore, it is possible to adjust the crystallinity of the triblock copolymers depending on the desired properties.

TABLE 2
DSC Data and Crystallinity for Hyperbranched-Linear-
Hyperbranched Triblock Copolymers (measured at 10° C./min, second
heating run).

| | | | ΔHₘ/ | Crystallinity/ | POM |
|---|---|---|---|---|---|
| sample | Tₘ/° C. | T_{g}/° C. | Jg⁻¹ | % | fraction/% |
| POM₄₅₀ | 161.7 | — | 138.0 | 42.3 | 100 |
| hbPG₁₅-b- | 153.9 | — | 115.9 | 41.1 | 85.9 |
| POM₄₅₀-b-hbPG₁₅ | | | | | |
| hbPG₂₀-b- | 155.1 | −67.0 | 110.0 | 40.9 | 82.0 |
| POM₄₅₀-b-hbPG₂₀ | | | | | |
| hbPG₃₁-b- | 150.7 | — | 82.6 | 33.7 | 74.6 |
| POM₄₅₀-b-hbPG₃₁ | | | | | |
| hbPG₆₀-b- | 157.4 | −47.4 | 90.2 | 16.8 | 60.3 |
| POM₄₅₀-b-hbPG₆₀ | | | | | |

To complete the investigation of the thermal properties, thermogravimetric analysis (TGA) of a POM macroinitiator, a triblock copolymer and a comparable homo-hbPG were performed. The triblock copolymer shows a higher degradation temperature than homo-POM starting at 380° C. The slight degradation starting at 200° C. can be explained by the initial degradation of unconverted POM macroinitiator. The degradation of the homo-POM starts at 220° C. Furthermore, the hbPG degrades between 320° C. and 440° C.

Surface Properties. To investigate the surface behavior of the novel triblock copolymers, the contact angles of some POM/triblock copolymer blends were measured. Therefore, a solution of the blends in HFIP were spin coated on silanized glass slides and the static contact angles at the liquid/vapor interface were measured by adding a droplet of water on the thin polymer film. The contact angle for POM constitutes 76.7° (Lit.: 76.8°)and with increasing content of hbPG₆₀-b-POM₄₅₀-b-hbPG₆₀ the it decreases linearly until reaching an angle of 54.5° for 100% hbPG₆₀-b-POM₄₅₀-b-hbPG₆₀ (FIG. 4). The hypergrafting results in a higher amount of hydroxyl groups in the polymer, which enlarges the hydrophilicity and simultaneously reduces the contact angle. In contrast, the contact angle increases by just mixing POM and hbPG. There is no bonding between the two different polymers and a phase separation is observable. Because of covalent bonding, this separation is not possible for the triblock copolymers in the same extent. So it is possible to adjust the hydrophilicity of a POM surface by adding different amounts of the triblock copolymer. In addition, this is verification for the successful hypergrafting.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer comprising a hyperbranched polyoxymethylene homopolymer or copolymer, the polyoxymethylene homopolymer or copolymer comprising a middle portion positioned between a first end portion and a second end portion, at least one of the end portions having a hyperbranched structure.

2. A polymer as defined in claim 1, wherein both end portions have a hyperbranched structure.

3. A polymer as defined in claim 1, wherein the middle portion comprises a linear structure having repeating oxymethylene units and optionally other oxyalkylene units.

4. A polymer as defined in claim 1, wherein the hyperbranched polyoxymethylene polymer comprises a triblock copolymer.

5. A polymer as defined in claim 1, wherein each hyperbranched portion includes at least 10 branches per molecule and generally less than about 500 branches per molecule.

6. A polymer as defined in claim 1, wherein each hyperbranched portion includes end units and wherein the end units comprise functional groups.

7. A polymer as defined in claim 6, wherein at least about 80% of the end units comprise the functional groups.

8. A polymer as defined in claim 6, wherein the functional groups comprise hydroxyl groups, amino groups, alkoxyl groups, esters or amides.

9. A polymer as defined in claim 1, wherein the hyperbranched portions are aliphatic.

10. A polymer as defined in claim 1, wherein the hyperbranched portions include ether linkages.

11. A polymer as defined in claim 1, wherein the hyperbranched portions comprise hyperbranched polyglycerol.

12. A polymer as defined in claim 1, wherein the polymer is amphiphilic.

13. A process for producing a hyperbranched polyoxymethylene polymer comprising:
at least partially deprotonating hydroxy terminal groups on a polyoxymethylene polymer or oligomer;
reacting the deprotonated polyoxymethylene polymer or oligomer with a multi-functional hyperbranching monomer, the multi-functional hyperbranching monomer grafting to the polymer or oligomer and further polymerizing to form a polyoxymethylene polymer with a hyperbranched portion.

14. A process as defined in claim 13, wherein the polyoxymethylene polymer or oligomer comprises a bishydroxy polyoxymethylene.

15. A process as defined in claim 13, wherein the polyoxymethylene polymer or oligomer is deprotonated by contacting with a base, while removing water.

16. A process as defined in claim 15, wherein the base comprises a hydroxide, such as cesium hydroxide, potassium hydroxide, sodium hydroxide, or mixtures thereof.

17. A process according to claim 13, wherein the polyoxymethylene polymer or oligomer has a linear structure.

18. A process according to claim 13, wherein the resulting polyoxymethylene polymer with a hyperbranched portion comprises a triblock copolymer.

19. A process as defined in claim 18, wherein the triblock copolymer includes a polyoxymethylene block positioned in between two hyperbranched blocks.

20. A process according to claim 13, wherein the multi-functional hyperbranching monomer comprises glycidol.

21. A process as defined in claim 20, wherein the polyoxymethylene polymer with a hyperbranched portion is produced through hypergrafting by anionic ring-opening multi-branching polymerization.

22. A process according to claim 13, wherein the weight ratio of the deprotonated polyoxymethylene polymer or oligomer to the multi-functional hyperbranching monomer is from about 1:0.1 to about 1:10.
